(19) United States
(12) Patent Application Publication
(10) Pub. No.: US 2026/0182767 A1
(43) Pub. Date: Jul. 2, 2026

(54) UPPER LID AND COOKING APPLIANCE

(71) Applicant: FOSHAN SHUNDE MIDEA ELECTRICAL HEATING APPLIANCES MANUFACTURING CO., LTD., Foshan (CN)

(72) Inventors: Shuzhan LI, Foshan (CN); Huayong LIU, Foshan (CN); Yongduo MIAO, Foshan (CN); Wang ZHOU, Foshan (CN); Yangyang LI, Foshan (CN)

(21) Appl. No.: 19/437,606

(22) Filed: Dec. 31, 2025

(30) Foreign Application Priority Data
Dec. 31, 2024 (CN) 202412000177.8

(51) Int. Cl. A47J 27/08; A47J 27/09; A47J 36/10

(52) U.S. Cl. CPC A47J 27/0815; A47J 27/09; A47J 36/10

(57) ABSTRACT

An upper lid includes lid body, pot lid rotatably connected to and disposed within the lid body, transmission member mounted at the lid body in liftable-lowerable manner and switchable between locked and released positions, and driven member rotatably mounted at the lid body and transmissively connected to the pot lid. The pot lid has locking and unlocking positions where the pot lid is locked to and unlock from an outer pot. Central line of the transmission member is coaxial with rotation axis of the driven member. One of the transmission and driven members has spiral groove, the other one has drive member inserted in the spiral groove. The transmission member is configured to, when switching from locked to released position, drive the driven member to rotate through engagement between the drive member and the spiral groove and drive the pot lid to rotate to switch from locking to unlocking position.

### CROSS-REFERENCE TO RELATED APPLICATION

This application claims priority to Chinese Application No. 2024120001778, filed on Dec. 31, 2024, the entire content of which is incorporated herein by reference.

### FIELD

The present disclosure relates to the field of cooking device technologies, and more particularly, to an upper lid and a cooking appliance.

### BACKGROUND

At present, many kinds of cooking appliances are available, including rice cookers, pressure cookers, electric cookers, etc. Taking the pressure cooker as an example, the pressure cooker has been widely used in family life. Whether the pressure cooker is used over an open flame or is electrically heated, convenience and operability are of the utmost concern to the majority of users. In particular, an operation method of opening or closing a lid of the pressure cooker directly affects its ease of use, and is also a very important issue that product providers pay attention to when improving their products.

The pressure cooker includes an upper lid and a pot body. The upper lid includes a lid body and a pot lid. The lid body covers the pot body. The pot lid has a locking position at which the pot lid is locked to the pot body and an unlocking position at which the pot lid is unlocked from the pot body. In the related art, the pressure cooker also includes a handle connected to the pot lid. The pot lid is driven to rotate by turning the handle, and the handle needs to be lifted to open the upper lid, which makes an operation of the pressure cooker complicated and is inconvenient for the user.

### SUMMARY

Embodiments of the present disclosure provide an upper lid and a cooking appliance, which aims to improve a problem that an operation of the cooking appliance in the related art is not simple enough.

To solve the above-mentioned technical problem, embodiments of the present disclosure provide an upper lid. The upper lid includes a lid body, a pot lid, a transmission member, and a driven member. The pot lid is rotatably connected to the lid body and disposed within the lid body. The pot lid has a locking position at which the pot lid is locked to the outer pot and an unlocking position at which the pot lid is unlocked from the outer pot. The transmission member is mounted at the lid body in a liftable and lowerable manner, and is switchable between a locked position and a released position. The driven member is rotatably mounted at the lid body and in transmission connection with the pot lid. A central line of the transmission member is coaxial with a rotation axis of the driven member. One of the transmission member and the driven member has a spiral groove, and the other one of the transmission member and the driven member is provided with a drive member inserted into the spiral groove. When the transmission member is switched from the locked position to the released position, the driven member is driven by the transmission member through an engagement between the drive member and the spiral groove to rotate in such a manner that the pot lid is driven to rotate to switch from the locking position to the unlocking position.

In some embodiments of the present disclosure, the spiral groove has a first component by which the transmission member extends beyond the lid body, and a second component by which the pot lid rotates from the unlocking position to the locking position.

In some embodiments of the present disclosure, a plurality of spiral grooves are provided and arranged at intervals in a rotation direction of the pot lid. A plurality of drive members are provided and arranged in one-to-one correspondence with the plurality of spiral grooves.

In some embodiments of the present disclosure, the driven member has a mounting recess. The spiral groove is formed on a wall of the mounting recess. An end of the transmission member extends into the mounting recess in which the drive member is disposed.

In some embodiments of the present disclosure, the lid body has a movement channel extending through the lid body in a lifting-lowering direction of the transmission member. An end of the transmission member is in transmission connection with the driven member, and the other end of the transmission member passes through the movement channel and extends out of the lid body.

In some embodiments of the present disclosure, the central line of the transmission member is coaxial with a rotation axis of the pot lid. The driven member is fixedly connected to the pot lid.

In some embodiments of the present disclosure, the driven member has a receiving groove formed in the driven member, and the pot lid has a pressure relief port formed at a center of the pot lid. The pressure relief port is in communication with the receiving groove. The upper lid further includes an exhaust valve movably mounted in the receiving groove, to open or close the pressure relief port.

In some embodiments of the present disclosure, the upper lid further includes a handle assembly connected to the transmission member. An exhaust channel is formed in the handle assembly and in communication with the exhaust valve. An exhaust port of the exhaust channel is formed at a side surface of the handle assembly.

In some embodiments of the present disclosure, the handle assembly includes a handle base housing and a bubble-breaking cover. The handle base housing is mounted at an upper surface of the lid body. The bubble-breaking cover covers the handle base housing. The handle base housing and the bubble-breaking cover are engaged with each other to enclose an exhaust channel.

In some embodiments of the present disclosure, the upper lid further includes a pressure relief button movably mounted at the handle assembly and in transmission connection with the exhaust valve. The pressure relief button is configured to drive the exhaust valve to lift in the receiving groove to bring the pressure relief port into communication with the exhaust channel.

In some embodiments of the present disclosure, the upper lid further includes a suspension shaft connecting the driven member with the pot lid. The pot lid is rotatably disposed below the lid body by the suspension shaft. The driven member is connected to a shift fork extending from the driven member towards an edge of the pot lid, and the shift fork has a driving groove. The pot lid is connected to a shift rod located at a distance from the rotation axis of the pot lid, and the shift rod is movably inserted into the driving groove.

In some embodiments of the present disclosure, the pot lid has a pressure relief port, and a gap is formed between the pressure relief port and the rotation axis of the pot lid in a radial direction of the pot lid. The upper lid further includes an exhaust valve and a sealing cover plate. The lid body has an arc-shaped avoidance groove. The sealing cover plate is movably mounted at the lid body and configured to constantly cover an opening of the arc-shaped avoidance groove. The exhaust valve is movably mounted at the sealing cover plate and configured to open or close the pressure relief port.

In some embodiments of the present disclosure, the central line of the transmission member is offset from a rotation axis of the pot lid. The driven member is provided with first transmission teeth at an outer circumferential wall of the driven member. The upper lid further includes a first rotation member provided with first driven teeth and rotatably mounted at the lid body. The first rotation member is in transmission connection with the pot lid. The first driven teeth are engaged with the first transmission teeth.

In some embodiments of the present disclosure, the pot lid has a pressure relief port at the rotation axis thereof. A rotation axis of the first rotation member is offset from the rotation axis of the pot lid. The first rotation member is provided with second transmission teeth. The upper lid further includes an exhaust valve movably mounted in the pressure relief port to open or close the pressure relief port, and a second rotation member movably mounted at the lid body to slide about the rotation axis of the pot lid. The second rotation member is fixedly connected to the pot lid and provided with second driven teeth, and the second driven teeth is engaged with the second transmission teeth.

In some embodiments of the present disclosure, the first driven teeth are separated from the second transmission teeth in a lifting-lowering direction of the transmission member. The first transmission teeth are separated from the second driven teeth in the lifting-lowering direction.

In some embodiments of the present disclosure, a second transmission member is in a fan-ring shape. The second transmission member is provided with the second driven teeth at an inner side surface of the second transmission member.

In some embodiments of the present disclosure, the first rotation member is provided with a connector protruding from an outer circumferential wall of the first rotation member. The connector is provided with the first driven teeth at a surface of the connector in a radial direction of the first rotation member. The lid body is provided with a limit protrusion located between the connector and the exhaust valve. A surface of the connector in a circumferential direction of the first rotation member abuts against the limit protrusion when the transmission member is positioned at the locked position or the released position.

In some embodiments of the present disclosure, the lid body has a sliding guide channel extending in a circumferential direction of the pot lid. The sliding guide channel extends through the lid body in a lifting-lowering direction of the transmission member. The upper lid further includes a sliding guide device. An end of the sliding guide device is fixedly connected to the pot lid, and the other end of the sliding guide device at least partially protrudes into the sliding guide channel.

In some embodiments of the present disclosure, the upper lid further includes a plurality of balance units mounted at the lid body. The plurality of balance units are connected to the pot lid and arranged at intervals in a circumferential direction of the pot lid.

In some embodiments of the present disclosure, the upper lid further includes a handle assembly mounted at an end of the transmission member away from the driven member.

A cooking appliance is further provided in the embodiments of the present disclosure. The cooking appliance includes a pot body and the upper lid as described above. The pot body includes an outer housing, an outer pot, and an inner pot. The upper lid is disposed at the pot body in an openable-closable manner, and a cooking cavity is formed by sealing the outer pot with the upper lid.

With the upper lid and the cooking appliance according to the embodiments of the present disclosure, the user only needs to operate the transmission member to move in the lifting-lowering direction to switch the transmission member from the locked position to the released position. During this process, the driven member is driven by the transmission member through the engagement between the drive member and the spiral groove to drive the pot lid to rotate to switch from the locking position to the unlocking position. The user then may continue to lift and pull the transmission member to open the upper lid. In addition, when closing the upper lid, the user only needs to close the upper lid through the transmission member, and switches the transmission member from the released position to the locked position. During this process, the driven member is driven by the transmission member through the engagement between the drive member and the spiral groove to rotate in such a manner that the pot lid is driven to rotate to switch from the unlocking position to the locking position. In this way, the user can use the cooking appliance conveniently. The driven member is driven by the transmission member through the engagement between the drive member and the spiral groove to rotate, which eliminates the need for a transmission structure and simplifies the overall structure of the upper lid.

### BRIEF DESCRIPTION OF THE DRAWINGS

In order to clearly explain technical solutions according to embodiments of the present disclosure, drawings used in the description of the embodiments are briefly described below. Obviously, the drawings as described below are merely some embodiments of the present disclosure. Based on these drawings, other designs can be obtained by those skilled in the art without creative effort.

FIG. 1 is a schematic structural view of an upper lid according to an embodiment of the present disclosure.

FIG. 2 is a cross-sectional view of an upper lid according to an embodiment of the present disclosure.

FIG. 3 is an engagement view of a transmission member and a driven member according to an embodiment of the present disclosure.

FIG. 4 is an exploded view of the transmission member and the driven member in FIG. 3.

FIG. 5 is a force diagram of a transmission member and a driven member according to an embodiment of the present disclosure.

FIG. 6 is a cross-sectional view of an upper lid according to another embodiment of the present disclosure.

FIG. 7 is a schematic structural view of an upper lid according to another embodiment of the present disclosure.

FIG. 8 is a partial cross-sectional view of an upper lid according to yet another embodiment of the present disclosure.

FIG. 9 is an exploded view of an upper lid according to still another embodiment of the present disclosure.

FIG. 10 is a partial cross-sectional view of an upper lid according to still another embodiment of the present disclosure.

FIG. 11 is another partial cross-sectional view of an upper lid according to still another embodiment of the present disclosure.

FIG. 12 is yet another partial cross-sectional view of an upper lid according to still another embodiment of the present disclosure.

FIG. 13 is a cross-sectional view of a partial structure of an upper lid according to further another embodiment of the present disclosure.

1, upper lid; 11, lid body; 111, movement channel; 112, limit protrusion; 113, sliding guide channel; 114, arc-shaped avoidance groove; 12, pot lid; 121, pressure relief port; 122, shift rod; 13, transmission member; 14, driven member; 141, mounting recess; 142, receiving groove; 143, first transmission teeth; 144, shift fork; 1441, driving groove; 15, spiral groove; 16, drive member; 17, exhaust valve; 18, first rotation member; 181, first driven teeth; 182, second transmission teeth; 183, connector; 19, second rotation member; 191, second driven teeth; 10a, sliding guide device; 10b, balance unit; 10c, handle assembly; 11c, exhaust channel; 12c, handle base housing; 13c, bubble-breaking cover; 10d, pressure relief button; 11d, press member; 12d, rocker plate; 10e, suspension shaft; 10f, sealing cover plate.

### DETAILED DESCRIPTION OF THE EMBODIMENTS

In order to make the objects, technical solutions, and advantages of the present disclosure more apparent, the present disclosure will be described in detail with reference to the accompanying drawings and embodiments. It should be understood that the embodiments described here are only used to explain, rather than limiting, the present disclosure.

At present, with the development of science and technology and the improvement of people's living standards, more and more cooking appliances have appeared in kitchens to meet different cooking needs and preferences. These appliances not only improve cooking efficiency, but also enrich tastes and nutrition of food.

Many kinds of cooking appliances are available, including rice cookers, pressure cookers, electric cookers, etc. Taking the pressure cooker as an example, the pressure cooker accelerates a cooking process through a sealed design that utilizes steam pressure. A working principle of the pressure cooker is to seal air inside a pot, which prevents steam from escaping, creating a pressure higher than atmospheric pressure inside the pot. This increased pressure can raise the boiling point of water, which allows the food to be cooked at a higher temperature. In this way, a cooking time is shortened while maintaining nutritional content and flavor of the food.

Whether the pressure cooker is used over an open flame or is electrically heated, convenience and operability are of the utmost concern to the majority of users. In particular, an operation method of opening or closing a lid of the pressure cooker directly affects the convenience of using a product. Main components of the pressure cooker include a pot body and an upper lid disposed at the pot body in an openable-closable manner. The upper lid and the pot body are equipped with a plurality of opening and closing structures to adapt to different usage needs and safety standards, which are mainly divided into a drop lid type, a screw-on type, and a clamp type.

In the related art, the pressure cooker further includes a handle assembly connected to a pot lid. The pot lid is driven to rotate by turning the handle assembly, and the handle assembly needs to be lifted to open the upper lid, which makes an operation of the pressure cooker complicated and is inconvenient for the user to use.

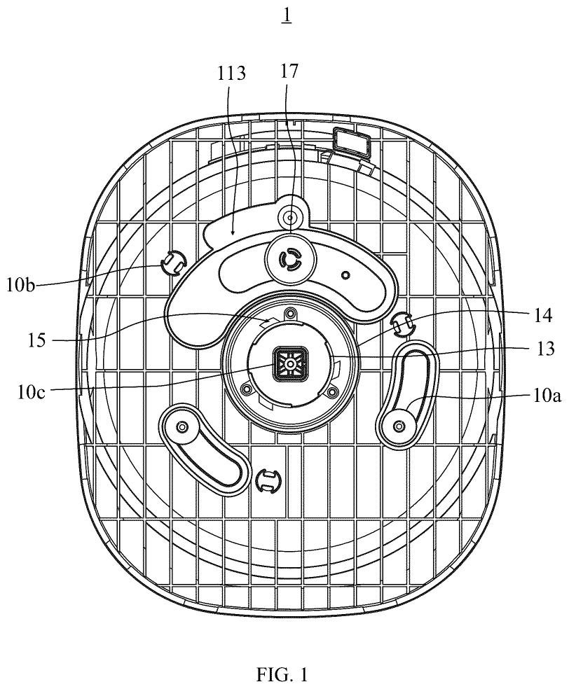

In view of the above, as illustrated in FIG. 1 to FIG. 4, an embodiment of the present disclosure provides an upper lid 1 and a cooking appliance, which aims to solve a problem that the cooking appliance in the related art is not simple enough to operate.

The cooking appliance may include one of a pressure cooker, a rice cooker, and an electric cooker, and a specific type of the cooking appliance is not limited in this embodiment. In order to facilitate explanation of the following contents, the cooking appliance in the following embodiments is the pressure cooker, and advantages of the cooking appliance of the present disclosure will be described in detail.

Taking the pressure cooker as an example, the pot body usually includes an outer pot and an inner pot. The inner pot is configured to directly hold the food and is detachably mounted in the outer pot, which is convenient for the user to clean and replace and can also prevent the user from directly coming into contact with a heated inner pot surface, reducing a risk of scalding. The outer pot can be used as an insulation layer to reduce a loss of heat, which enables food in the inner pot to be heated more quickly and evenly.

The upper lid 1 is disposed at a pot body in an openable-closable manner. The pot body includes an outer housing, an outer pot, and an inner pot. The upper lid 1 includes a lid body 11, a pot lid 12, a transmission member 13, and a driven member 14. The pot lid 12 is rotatably connected to the lid body 11 and disposed within the lid body 11. The pot lid 12 has a locking position at which the pot lid 12 is locked to the outer pot and an unlocking position at which the pot lid 12 is unlocked from the outer pot. A cooking cavity is formed by sealing the outer pot with the pot lid 12. The transmission member 13 is mounted at the lid body 11 in a liftable and lowerable manner, and the transmission member 13 is switchable between a locked position and a released position. The driven member 14 is rotatably mounted at the lid body 11 and in transmission connection with the pot lid 12. A central line of the transmission member 13 is coaxial with a rotation axis of the driven member 14. One of the transmission member 13 and the driven member 14 has a spiral groove 15, and the other one of the transmission member 13 and the driven member 14 is provided with a drive member 16 inserted into the spiral groove 15. When the transmission member 13 is switched from the locked position to the released position, the driven member 14 is driven by the transmission member 13 through an engagement between the drive member 16 and the spiral groove 15 to rotate in such a manner that the pot lid 12 is driven to rotate to switch from the locking position to the unlocking position. The transmission member 13 may have an irregular structure, or a columnar structure, which is not limited here.

The pot lid 12 may be locked with the pot body in several manners. For example, the pot lid 12 is provided with a thread at an outer circumferential side of the pot lid 12, and the pot body has a thread groove at an inner side wall of the pot body. When the pot lid 12 is located at the locking position, the pot lid 12 and the pot body are locked through an engagement between the thread and the thread groove. When the pot lid 12 is located at the unlocking position, the thread is separated from the thread groove in a circumferential direction of the lid body 11. In another example, the pot lid 12 is provided with a snap portion at the outer circumferential side of the pot lid 12, and the pot body has a snap groove at the inner side wall of the pot body. The pot lid 12 and the pot body are locked through an engagement between the snap portion and the snap groove. When the pot body is located at the unlocking position, the snap portion is separated from the snap groove in the circumferential direction of the lid body 11. Other locking mechanisms are not enumerated herein.

The transmission member 13 is mounted at the lid body 11 in the liftable and lowerable manner, and lid body 11 needs to limit the transmission member 13 circumferentially to prevent the transmission member 13 from rotating. For example, the transmission member 13 is provided with a limit portion protruding in circumferential direction of the transmission member 13. The lid body 11 has a guide groove recessed in a vertical direction, and the limit portion protrudes into the guide groove. The transmission member 13 is limited circumferentially through an engagement between a groove wall of the guide groove in the circumferential direction of the transmission member 13 and the limit portion. In another example, the transmission member 13 has a limit groove in the circumferential direction of the transmission member 13, and the limit groove extends in the vertical direction. The lid body 11 is provided with a guide post protruding into the limit groove. The transmission member 13 is limited circumferentially through an engagement between a groove wall of the limit groove in the circumferential direction of the transmission member 13 and the guide post. Other limiting manners are not enumerated herein.

The driven member 14 is rotatably mounted at the lid body 11, and the lid body 11 needs to limit the driven member 14 in an axial direction to prevent the driven member 14 from moving in a lifting-lowering direction. For example, the driven member 14 is provided with a limit portion protruding in a circumferential direction of the driven member 14. The lid body 11 has the guide groove recessed in the circumferential direction of the driven member 14, and the limit portion protrudes into the guide groove. The driven member 14 is limited axially through an engagement between a groove wall of the guide groove in the axial direction of the driven member 14 and the limit portion. In another example, the driven member 14 has a limit groove extending in the circumferential direction of the driven member 14. The lid body 11 is provided with a guide post protruding into the limit groove. The driven member 14 is limited axially through an engagement between a groove wall of the limit groove in the axial direction of the driven member 14 and the guide post. Other limiting manners are not enumerated herein.

It should be noted that the transmission member 13 lifts and lowers along the central li of the transmission member 13, and the central line of the transmission member 13 is coaxial with the rotation axis of the driven member 14. It should be understood that the driven member 14 rotates about the central line of the transmission member 13. The transmission member 13 may move along a rotation axis of the pot lid 12, and the transmission member 13 may also move at a position located at a distance from the rotation axis in a radial direction of the pot lid 12, which is not limited here.

It should be understood that the drive member 16 may be disposed at the transmission member 13. In this case, the spiral groove 15 is formed on the driven member 14. The drive member 16 may also be disposed at the driven member 14. In this case, the spiral groove 15 is formed on the transmission member 13. The drive member 16 may be in many shapes. The drive member 16 may be in a cylindrical shape, a square shape, or other shapes, which is not limited herein. In an exemplary embodiment of the present disclosure, the drive member 16 is in the cylindrical shape. In this case, wear between an outer circumferential wall of the drive member 16 and a groove wall of the spiral groove 15 can be reduced.

It should be noted that a downward orthographic projection of the spiral groove 15 is located on a circumference of a circle, and the central line of the transmission member 13 in the present disclosure is a line extending in a lifting-lowering direction of the transmission member 13 and passing through a center of the circle.

When opening the upper lid 1, the user operates the transmission member 13 to move in the lifting-lowering direction to switch from the locked position to the released position. During this process, the driven member 14 is driven by the transmission member 13 through the engagement between the drive member 16 and the spiral groove 15 to rotate in such a manner that the pot lid 12 is driven to rotate to switch from the locking position to the unlocking position. The user then continues to operate the transmission member 13 in the lifting-lowering direction to open the upper lid 1.

When closing the upper lid 1, the user operates the transmission member 13 to cover the inner pot with the upper lid 1, and then operates the transmission member 13 to move in the lifting-lowering direction to switch from the released position to the locking position. During this process, the driven member 14 is driven by the transmission member 13 through the engagement between the drive member 16 and the spiral groove 15 to rotate in such a manner that the pot lid 12 is driven to rotate to switch from the unlocking position to the locking position.

With the upper lid 1 and the cooking appliance according to the embodiments of the present disclosure, the user only needs to operate the transmission member 13 to move in the lifting-lowering direction to switch from the locked position to the released position. During this process, the driven member 14 is driven by the transmission member 13 through the engagement between the drive member 16 and the spiral groove 15 to rotate in such a manner that the pot lid 12 is driven to rotate to be switched from the locking position to the unlocking position. The user then may lift and pull the transmission member 13 to open the upper lid 1. In addition, when closing the upper lid 1, the user only needs to close the upper lid 1 through the transmission member 13, and switches the transmission member 13 from the released position to the locked position. During this process, the driven member 14 is driven by the transmission member 13 through the engagement between the drive member 16 and the spiral groove 15 to rotate in such a manner that the pot lid 12 is driven to rotate to switch from the unlocking position to the locking position. In this way, the user can use the cooking appliance conveniently. The driven member 14 is driven by the transmission member 13 through the engagement between the drive member 16 and the spiral groove 15 to rotate, which eliminates the need for a transmission structure and simplifies the overall structure of the upper lid 1.

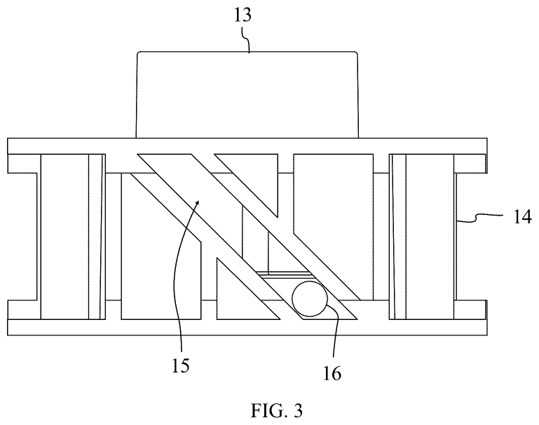

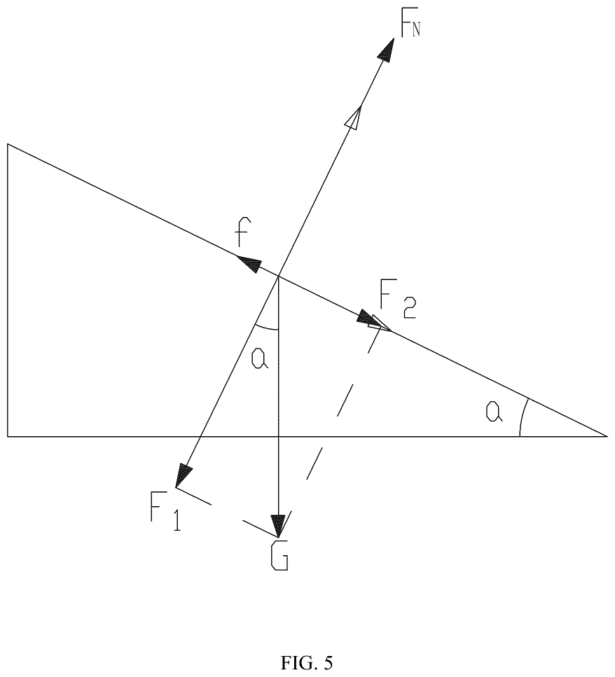

In an exemplary embodiment of the present disclosure, as illustrated in FIG. 3 to FIG. 5, the spiral groove 15 has a first component by which the transmission member 13 extends beyond the lid body 11, and a second component by which the pot lid 12 rotates from the unlocking position to the locking position. It should be understood that the released position is located above the locked position. When the user lifts and pulls the transmission member 13, the transmission member 13 is switched from the locked position to the released position, and the drive member 16 abuts against an upper wall surface of the spiral groove 15 and rotates relative to the spiral groove 15 in a direction in which the pot lid 12 is switched to the unlocking position. At this time, the driven member 14 rotates in the direction in which the pot lid 12 is switched to the unlocking position. In this way, the user only needs to lift and pull the transmission member 13 to switch the pot lid 12 from the locking position to the unlocking position, thereby opening the upper lid 1. In addition, the user only needs to press the transmission member 13 to close the upper lid 1 while switching the pot lid 12 from the unlocking position to the locking position, which is convenient for the user to operate. The transmission member 13 can also ensure that the pot lid 12 is stably located at the locking position under an action of gravity G. Therefore, safety of the cooking appliance is improved.

The transmission member 13 moves downward under the action of the gravity G. As a result, the drive member 16 abuts against the groove wall of the spiral groove 15. The gravity G is resolved into a pressing force F1 perpendicular to the groove wall of the spiral groove 15 and a movement force F2 parallel to the groove wall of the spiral groove 15. The spiral groove 15 correspondingly generates a support force FN opposite to the pressing force F1 and a friction force f opposite to the movement force F2. As a result, the driven member 14 is driven to rotate by a friction force f generated by the spiral groove 15.

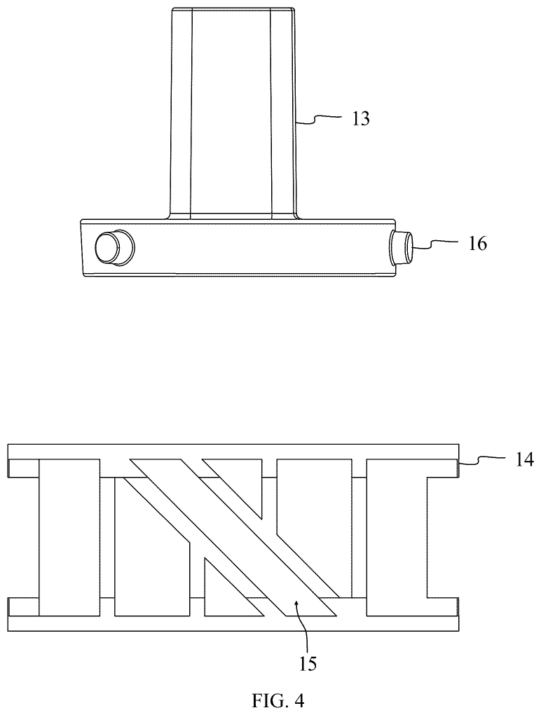

In some embodiments of the present disclosure, as illustrated in FIG. 4, a plurality of spiral grooves 15 are provided and arranged at intervals in a rotation direction of the pot lid 12. A plurality of drive members 16 are provided and arranged in one-to-one correspondence with the plurality of spiral grooves 15. With this arrangement, transmission stability between the transmission member 13 and the driven member 14 is improved through the engagement between the plurality of drive members 16 and the plurality of spiral grooves 15. In addition, when one of the drive members 16 or one of the spiral grooves 15 is damaged, the transmission member 13 may be driven to rotate through the engagement between the rest of the drive members 16 and the rest of the spiral grooves 15. Therefore, service lives of the transmission member 13 and the driven member 14 are prolonged.

There are many positional relationships between the transmission member 13 and the driven member 14. For example, the transmission member 13 is sleeved on an outer circumferential wall of the driven member 14 by the groove formed on the transmission member 13, or the driven member 14 is sleeved on an outer circumferential wall of the transmission member 13 via a groove formed on the driven member 14. The present disclosure is not limited in this regard.

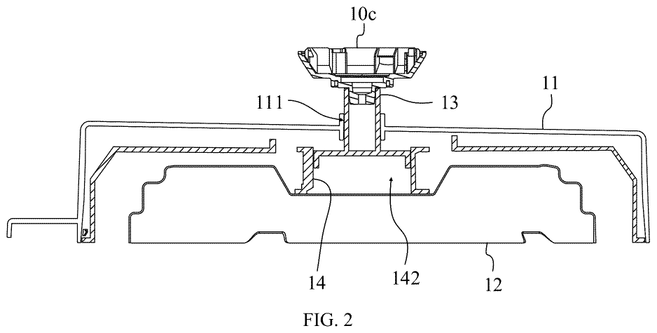

In some embodiments of the present disclosure, as illustrated in FIG. 2, the driven member 14 has a mounting recess 141. The spiral groove 15 is formed on a wall of the mounting recess 141. An end of the transmission member 13 protrudes into the mounting recess 141 in which the drive member 16 is disposed. It should be understood that the driven member 14 is sleeved on the outer circumferential wall of the transmission member 13. In this way, the drive member 16 is located in the mounting recess 141, reducing an influence of external environment on the drive member 16.

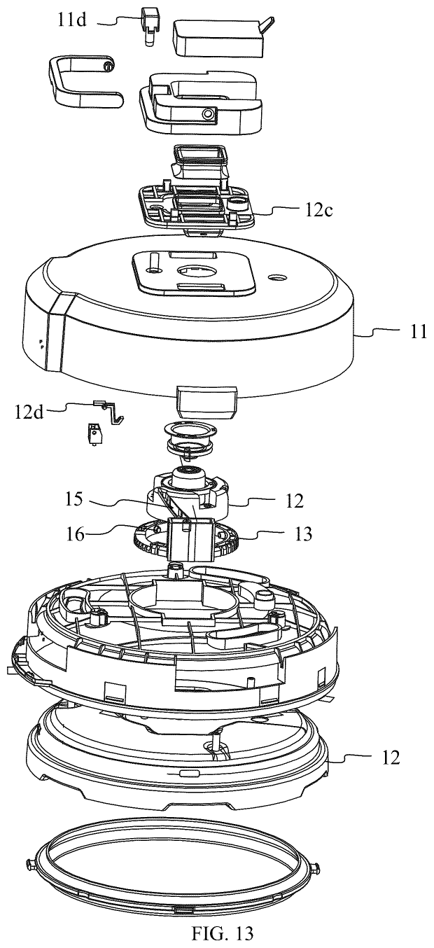

In some other embodiments of the present disclosure, the driven member 14 has a mounting recess 141. The drive member 16 is provided on a wall of the mounting recess 141 and protrudes therefrom. An end of the transmission member 13 protrudes into the mounting recess 141 in which the spiral groove 15 is formed. As illustrated in FIG. 13, it should be understood that the driven member 14 is sleeved on the outer circumferential wall of the transmission member 13. In this way, the drive member 16 is located in the mounting groove 141, reducing the influence of the external environment on the drive member 16.

In some embodiments of the present disclosure, as illustrated in FIG. 2, the lid body 11 has a movement channel 111 extending through the lid body 11 in the lifting-lowering direction of the transmission member 13. The end of the transmission member 13 is in transmission connection with the driven member 14, and the other end of the transmission member 13 passes through the movement channel 111 and extends out of the lid body 11. In this way, the transmission member 13 can be limited through the movement channel 111, ensuring that the transmission member 13 moves in the lifting-lowering direction while preventing the transmission member 13 from being separated from the lid body 11.

In some embodiments of the present disclosure, as illustrated in FIG. 2, the central line the transmission member 13 is coaxial with the rotation axis of the pot lid 12. The driven member 14 is fixedly connected to the pot lid 12. In this way, the driven member 14 rotates about the rotation axis of the pot lid 12 in such a manner that the pot lid 12 is driven by the transmission member 13 to rotate. Therefore, the structure of the upper lid 1 is simplified.

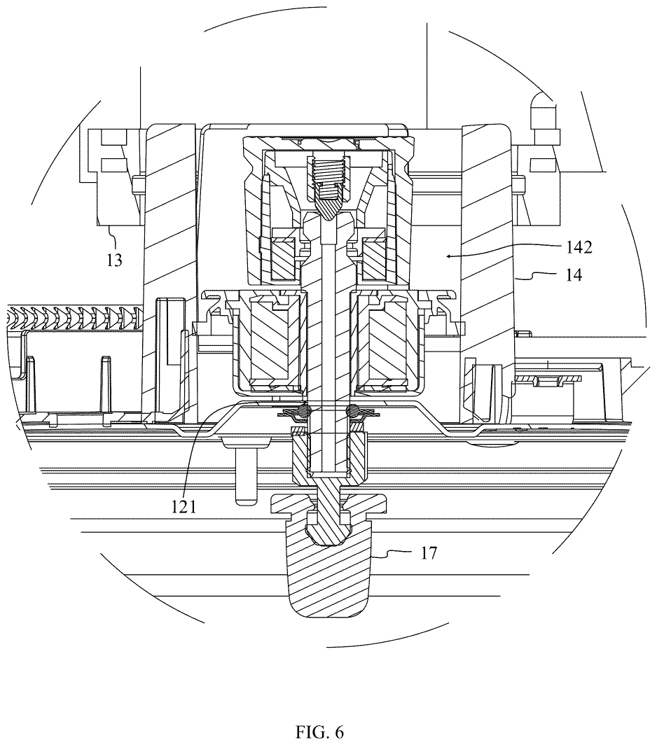

Further, as illustrated in FIG. 6, the driven member 14 has a receiving groove 142 located at the rotation axis of the driven member 14. The pot lid 12 has a pressure relief port 121 located at the rotation axis of the driven member 14. The pot lid 12 is in communication with the receiving groove 142. The upper lid 1 further includes an exhaust valve 17 movably mounted in the receiving groove 142 to open or close the pressure relief port 121. In this way, when the pot lid 12 and the driven member 14 rotate, the exhaust valve 17 does not interfere with the pot lid 12. In addition, an axial space of the driven member 14 is fully utilized, reducing an overall volume of the upper lid 1.

It should be noted that, when the driven member 14 and the pot lid 12 rotate, the exhaust valve 17 may rotate together, or the exhaust valve 17 may be stationary, which is not limited herein. When the exhaust valve 17 may rotate together with the driven member 14 and the pot lid 12, the driven member 14 is in transmission connection with the pot lid 12 by the exhaust valve 17.

In a case where pressure cooking is required, the exhaust valve 17 blocks the pressure relief port 121, steam in the cooking cavity of the pot body cannot be freely released, and a boiling point of the water increases, which increases a cooking temperature and pressure, and accelerates the cooking process of ingredients. In a case where pressure-free cooking is required, the exhaust valve 17 at least partially leaves the pressure relief port 121 in such a manner that the cooking cavity of the pot body is in communication with an external environment via the pressure relief port 121, balancing a pressure in the cooking cavity and the environmental pressure.

It should be understood that the exhaust valve 17 needs to be exposed to the lid body 11. Thus, the transmission member 13 has an avoidance channel. The avoidance channel extends through the transmission member 13 in the lifting-lowering direction and is in communication with the receiving groove 142. The exhaust valve 17 is exposed from the avoidance channel.

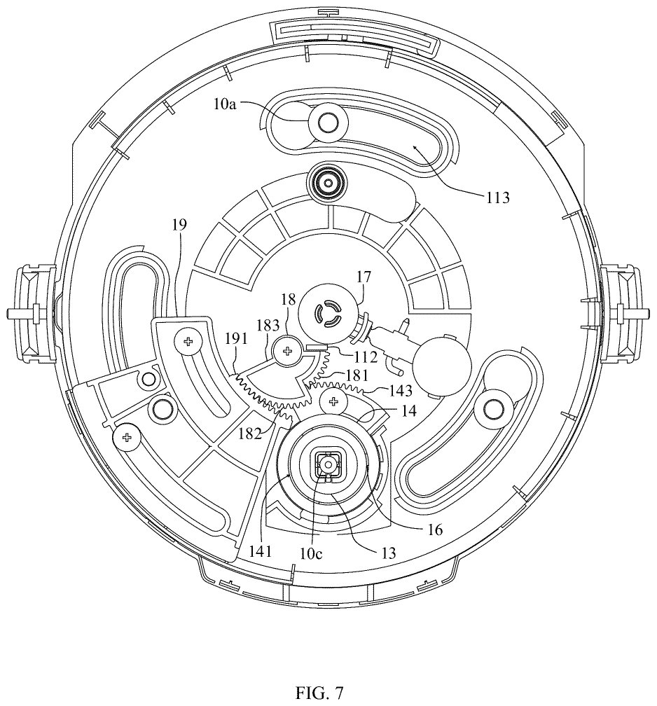

In some embodiments of the present disclosure, as illustrated in FIG. 7, the central line of the transmission member 13 is offset from the rotation axis of the pot lid 12. The driven member 14 is provided with first transmission teeth 143 at the outer circumferential wall of the driven member 14. The upper lid 1 further includes a first rotation member 18. The first rotation member 18 is provided with first driven teeth 181 and rotatably mounted at the lid body 11. The first rotation member 18 is in transmission connection with the pot lid 12. The first driven teeth 181 are engaged with the first transmission teeth 143. In this way, the transmission member 13 moves in the lifting-lowering direction to drive the driven member 14 to rotate, the first rotation member 18 is driven by the driven member 14 through an engagement between the first transmission teeth 143 and the first driven teeth 181 to rotate, and the pot lid 12 is driven by the first rotation member 18 to rotate.

A rotation axis of the first rotation member 18 may be coaxial with the rotation axis of the pot lid 12. It should be understood that the first rotation member 18 rotates about the rotation axis of the pot lid 12. In this case, the first rotation member 18 is fixedly connected to the pot lid 12. The rotation axis of the first rotation member 18 may be offset from the rotation axis of the pot lid 12 in the radial direction of the pot lid 12, which is not limited here.

In an exemplary embodiment of the present disclosure, as illustrated in FIG. 7, the pot lid 12 has the pressure relief port 121 at the rotation axis thereof. The rotation axis of the first rotation member 18 is offset from the rotation axis of the pot lid 12. The first rotation member 18 is provided with second transmission teeth 182. The upper lid 1 further includes the exhaust valve 17 and a second rotation member 19. The exhaust valve 17 is movably mounted in the pressure relief port 121 to open or close the pressure relief port 121. The second rotation member 19 is movably mounted at the lid body 11 and fixedly connected to the pot lid 12. The second rotation member 19 is provided with second driven teeth 191 engaged with the second transmission teeth 182. It should be noted that the second rotation member 19 may rotate about the rotation axis of the pot lid 12.

In this way, the transmission member 13 moves in the lifting-lowering direction to drive the driven member 14 to rotate, the first rotation member 18 is driven by the driven member 14 through the engagement between the first transmission teeth 143 and the first driven teeth 181, and the second rotation member 19 is driven by the first rotation member 18 through an engagement between the second transmission teeth 182 and the second driven teeth 191 to rotate, thereby driving the pot lid 12 to rotate. During this process, when the pot lid 12 and the driven member 14 rotate, the exhaust valve 17 does not interfere with the pot lid 12.

Further, as illustrated in FIG. 7, the first driven teeth 181 are separated from the second transmission teeth 182 in the lifting-lowering direction. The first transmission teeth 143 are separated from the second driven teeth 191 in the lifting-lowering direction. In this way, interference between the driven member 14 and the second rotation member 19 is avoided. In addition, a space of the upper lid 1 in the lifting-lowering direction of the transmission member 13 is fully utilized.

In an exemplary embodiment of the present disclosure, as illustrated in FIG. 7, a second transmission member 13 is in a fan-ring shape. The second transmission member 13 is provided with second driven teeth 191 at an inner side surface of the second transmission member 13. In this way, machining of the second transmission member 13 is facilitated. In addition, in a mounting process of the second transmission member 13, it is only needed to overlap a center of a fan-shaped ring with the rotation axis of the pot lid 12 to ensure that the second transmission member 13 moves about the rotation axis of the pot lid 12. Therefore, assembly of the second transmission member 13 is facilitated.

In some embodiments of the present disclosure, as illustrated in FIG. 7, the first rotation member 18 is provided with a connector 183 protruding from an outer circumferential wall of the first rotation member 18. The connector 183 is provided with first driven teeth 181 at a surface of the connector 183 in a radial direction of the first rotation member 18. The lid body 11 is provided with a limit protrusion 112 located between the connector 183 and the exhaust valve 17. A surface of the connector 183 in a circumferential direction of the first rotation member 118 abuts against the limit protrusion 112 when the transmission member 13 is positioned at the locked position or the released position. In this way, the limit protrusion 112 abuts against the connector 183 to avoid interference between the connector 183 and the exhaust valve 17. In addition, a rotation range of the first rotation member 18 can be limited. As a result, a rotation range of the driven member 14 is limited by the first rotation member 18 through the first driven teeth 181 and the first transmission teeth 143. In this way, a movement range of the transmission member 13 is limited by the driven member 14 through the spiral groove 15 and the drive member 16.

In some embodiments of the present disclosure, as illustrated in FIG. 7, the lid body 11 has a sliding guide channel 113 extending in a circumferential direction of the pot lid 12. The sliding guide channel 113 extends through the lid body 11 in the lifting-lowering direction of the transmission member 13. The upper lid 1 further includes a sliding guide device 10a. An end of the sliding guide device 10a is fixedly connected to the pot lid 12, and the other end of the sliding guide device 10a at least partially protrudes into the sliding guide channel 113. In this way, rotation of the pot lid 12 can be guided by a guide slide structure. A plurality of sliding guide devices may be provided and arranged at intervals in the circumferential direction of the pot lid 12. In this case, there may be cases for the sliding guide devices 10a. For example, the plurality of sliding guide devices 10a are all mounted in one sliding guide channel 113. In another example, a plurality of sliding guide channels 113 are formed and arranged in one-to-one correspondence with the plurality of sliding guide devices 10a. In yet another example, the plurality of sliding guide channels 113 are provided, and some of the sliding guide devices 10a are mounted in the same sliding guide channel 113. Other cases will not be listed herein.

Since a volume of the pot lid 12 is large and the pot lid 12 is only rotatably connected to the pot body at the rotation axis of the pot lid 12, the pot lid 12 is easily inclined. To this end, as illustrated in FIG. 7, the upper lid 1 further includes a plurality of balance units 10b mounted at the lid body 11. The plurality of balance units 10b are connected to the pot lid 12 and arranged at intervals in the circumferential direction of the pot lid 12.

In this way, when the pot lid 12 is inclined, the balance unit 10b of the pot lid 12 close to the lid body 11 is compressed to generate a thrust, and a part of the pot lid 12 away from the lid body 11 is pulled to generate a pulling force, in such a manner that the pot lid 12 can be adjusted to a relatively horizontal position, and thus problems such as hanging pots and sucking pots are avoided. The balance unit 10b may adjust the pot lid 12 by an elastic force, or the balance unit 10b may adjust the pot lid 12 by a magnetic force, and the present disclosure is not limited in the regard.

In some embodiments of the present disclosure, as illustrated in FIG. 2, the upper lid 1 further includes a handle assembly 10c mounted at an end of the transmission member 13 away from the driven member 14. In this way, the user can drive the transmission member 13 to move through the handle assembly 10c, which facilitates user's operation of the cooking appliance.

The handle assembly 10c may be in many shapes. The handle assembly 10c may be in an arched shape, or in a “7” shape, or in other shapes that are convenient for the user to be grasped, and the present disclosure is not limited in this regard. Many ways to mount the handle assembly 10c at the transmission member 13 are available. The handle assembly 10c may be integrally formed with the transmission member 13. The handle assembly 10c may be mounted at the transmission member 13 through a threaded connection. The handle assembly 10c may be mounted at the transmission member 13 in a snap-fit manner. The mounting manners of the handle assembly 10 will not be listed here. In an exemplary embodiment, the handle assembly 10c is detachably connected to the transmission member 13. When the handle assembly 10c or the transmission member 13 is damaged, only the corresponding component needs to be replaced. Therefore, a maintenance cost is reduced in a later period.

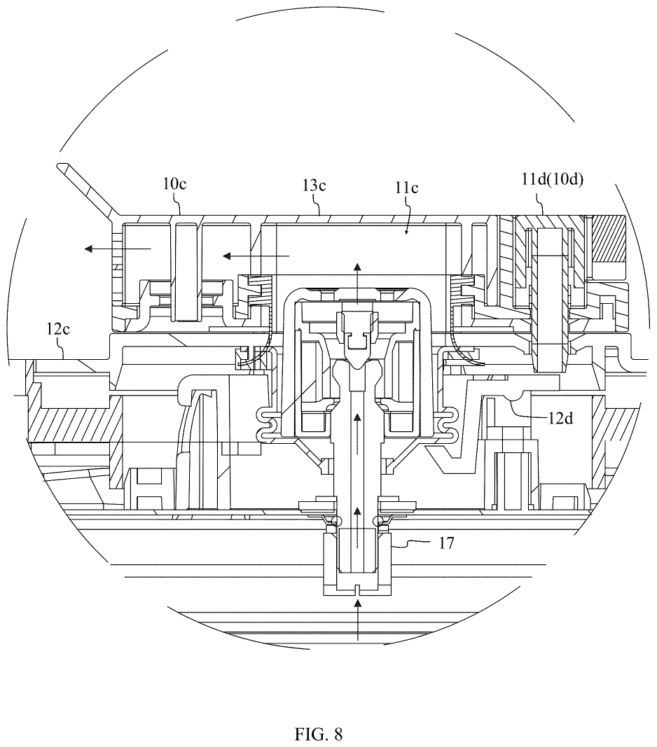

As illustrated in FIG. 8, in some embodiments of the present disclosure, in combination with the above, the driven member 14 has a receiving groove 142 formed in the driven member 14, and the pot lid 12 has a pressure relief port 121 formed at the center of the pot lid 12. In a case where the pressure relief port 121 is in communication with the receiving groove 142, an exhaust channel 11c is formed in the handle assembly 10c and in communication with the exhaust valve 17, and an exhaust port of the exhaust channel 11c is formed at a side surface of the handle assembly 10c. That is, in the present disclosure, by forming the exhaust port at the side surface of the handle assembly 10c, high-temperature steam is sprayed from the pressure relief port 121 and the exhaust valve 17 at the side surface of the handle assembly 10c. In this way, the high-temperature steam can be effectively prevented from being directly exposed to hands of the user during an operation of lifting the handle assembly 10c upwards to open or close the pot lid, thereby ensuring safety of the user.

In an embodiment of the present disclosure in which the exhaust valve 17 is disposed in a transmission mechanism, and the transmission member 13 of the transmission mechanism may be sleeved on the driven member 14. In this case, the receiving groove 142 is located within the driven member 14. Further, the handle assembly 10c is directly fixedly connected to the transmission member 13. As illustrated in FIG. 13, the handle assembly 10c and the transmission member 13 can be connected to each other by fasteners. In other embodiments, the transmission member 13 may be located inside the driven member 14. In this case, the receiving groove 142 may be formed on an inner side of the transmission member 13, and the handle assembly 10c is also fixedly connected to the transmission member 13.

In an exemplary embodiment of the present disclosure, as illustrated in FIG. 8, the handle assembly 10c includes a handle base housing 12c and a bubble-breaking cover 13c. The handle base housing 12c is mounted at an upper surface of the lid body 11. The bubble-breaking cover 13c covers the handle base housing 12c. The handle base housing 12c and the bubble-breaking cover 13c are engaged with each other to enclose the exhaust channel 11c. A plurality of ribs are provided at one of the bubble-breaking cover 13c and the handle base housing 12c, and the plurality of ribs are arranged at intervals. The plurality of ribs are located in the exhaust channel 11c after the exhaust channel 11c is formed. In this way, a bubble breaking effect can be achieved through pressing bubbles by the plurality of ribs when the high-temperature steam contains the bubbles.

In actual use, in order to open the pot lid, pressure relief needs to be carried out first. Therefore, the upper lid in this embodiment also includes a pressure relief button 10d. The pressure relief button 10d is movably mounted at the handle assembly 10c, and is in transmission connection with the exhaust valve 17. The pressure relief button 10d is configured to drive the exhaust valve 17 to lift in the receiving groove 142 to bring the pressure relief port 121 into communication with the exhaust channel 11c.

In an exemplary embodiment of the present disclosure, as illustrated in FIG. 8, the pressure relief button 10d may include two portions including a press member 11d and a rocker plate 12d. The press member 11d is provided with a reset member, and the rocker plate 12d is in contact with the press member 11d. The press member 11d and the rocker plate 12d are both movably mounted at the handle assembly 10c. In an exemplary embodiment, the press member 11d and the rocker plate 12d are both mounted at the above-mentioned handle base housing 12c, and the press member 11d is partially exposed from the handle base housing 12c for the user to contact and operate. As exemplarily illustrated, the press member 11d is movably mounted in a groove body of the handle base housing 12c vertically. The rocker plate 12d is connected to the handle base housing 12c by a pivot, and an end of the rocker plate 12d protrudes to a position below the exhaust valve 17. When the press member 11d is pressed downwardly, the press member 11d causes an end of the rocker plate 12d abutting against the exhaust valve 17 to tilt upwards to drive the exhaust valve 17 to lift in the receiving groove 142. In this way, the exhaust valve 17 can be in communication with the exhaust channel 11c of the pressure relief port 121 to achieve the pressure relief. In a case that an external force is removed, a reset may be achieved under an action of the reset member (spring). In this embodiment, by arranging the pressure relief button on the handle base housing 12c, the pressure relief can be carried out before the pot lid is opened. As a result, the pot lid can be opened smoothly, thereby improving convenience of an entire lid opening operation.

It should be noted that in addition to the above-mentioned embodiments in which the pressure relief button 10d includes the press member 11d and the rocker plate 12d, the pressure relief button 10d may also be configured with a part of the handle assembly 10c and the rocker plate 12d that are directly transmission-connected to each other. In this case, the handle assembly 10c can directly drive the rocker plate 12d to move in a lid opening process to realize a pressure releasing operation before the lid opening operation. In an exemplary embodiment of the present disclosure, the handle assembly 10c includes a handle body rotatably connected to the handle base housing 12c and in transmission connection with the rocker plate 12d. When the user lifts the handle body, the rocker plate 12d is driven to move to achieve the above-mentioned pressure releasing operation using lever-based transmission. In other embodiments, the pressure relief button 10d may also be configured with a part of the transmission member 13 and the rocker plate 12d that are directly transmission-connected to each other. In this case, during opening the lid, the handle assembly 10c drives the rocker plate 12d to move within a predetermined stroke, releasing the pressure before the lid opening operation, and then performing the lid opening operation after the pressure is released.

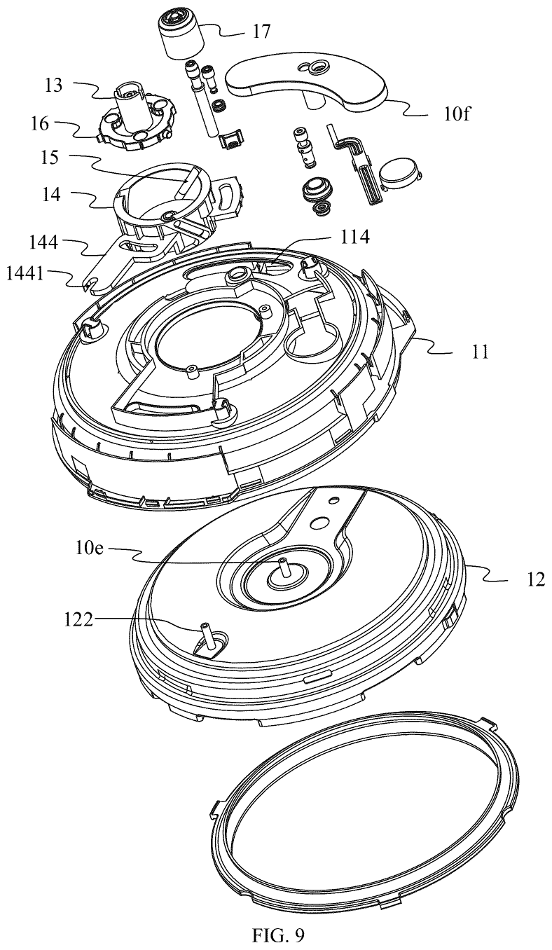

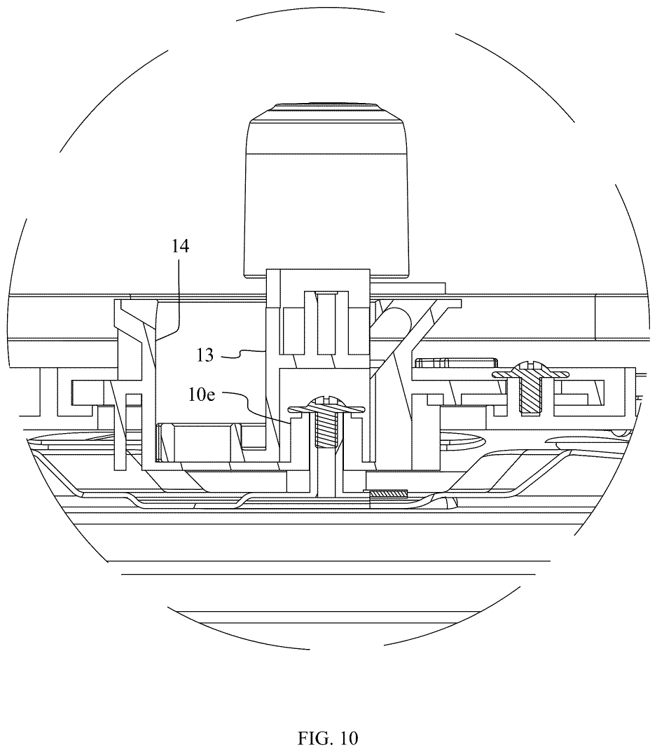

In other embodiments, the exhaust valve 17 may not be located at a center position of the pot lid 12. In an embodiment, as illustrated in FIG. 9 to FIG. 11, the upper lid further includes a suspension shaft 10e connecting the driven member 14 with the pot lid 12. The pot lid 12 is rotatably disposed below the lid body 11 by the suspension shaft 10e. The driven member 14 is connected to a shift fork 144 extending from the driven member 14 towards an edge of the pot lid 12. The shift fork 144 has a driving groove 1441. The pot lid 12 is connected to a shift rod 122 located at a distance from the rotation axis of the pot lid 12. The shift rod 122 is movably inserted into the driving groove 1441. In this embodiment, the pot lid 12 is rotatably disposed below the lid body 11 with a relatively simple structure. A connection structure is simple, and the shift fork 144 drives the shift rod 122 to drive the pot lid 12 to rotate. Since a lever arm of the shift fork 144 is long and torque in a driving process is large, the lid opening operation will be more stable and smoother.

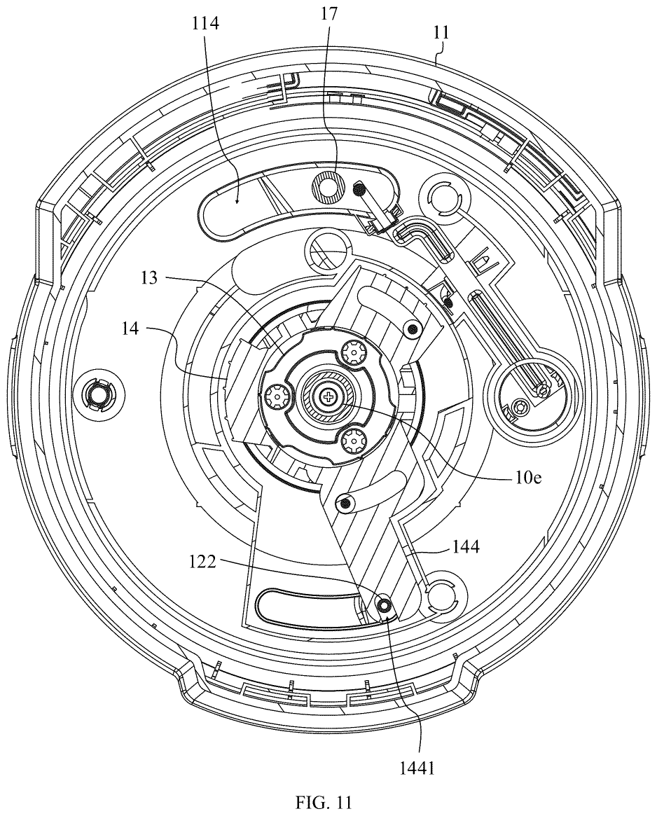

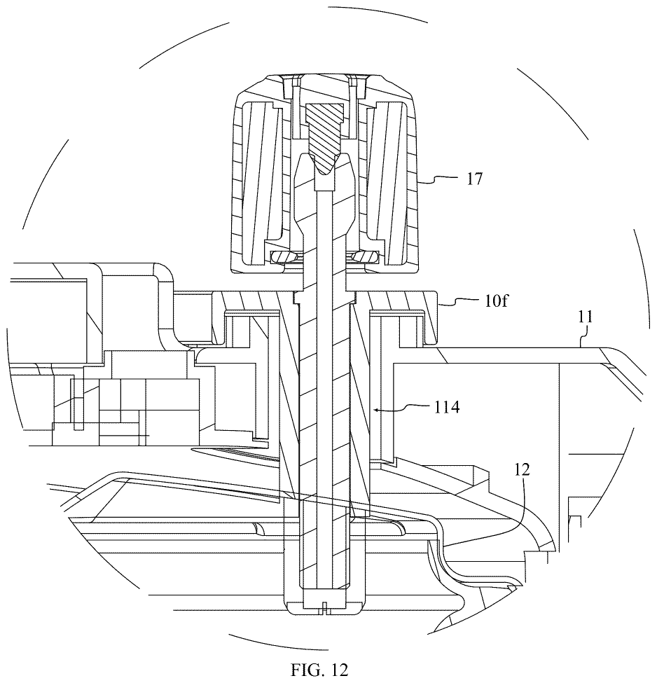

In view of the above embodiments, as illustrated in FIG. 11 and FIG. 12, the pressure relief port 121 at the pot lid 12 is offset from the center of the pot lid 12. That is, a gap is formed between the pressure relief port 121 and the rotation axis of the pot lid 12 in the radial direction of the pot lid 12. Further, the upper lid 1 also includes an exhaust valve 17 and a sealing cover plate 10f. The lid body 11 has an arc-shaped avoidance groove 114. The sealing cover plate 10f is movably mounted at the lid body 11 and configured to constantly cover an opening of the arc-shaped avoidance groove 114. The exhaust valve 17 is movably mounted at the sealing cover plate 10f and configured to open or close the pressure relief port 121.

In this embodiment, as illustrated in FIG. 12, the exhaust valve 17 rotates about a rotation center of the pot lid 12 together with the pot lid 12. The pot lid 12 can move relative to the sealing cover plate 10f towards the pot lid 12 and away from the pot lid 12. In an exemplary embodiment, the exhaust valve 17 movably extends through the sealing cover plate 10f, and the exhaust valve 17 is sleeved on an exhaust pipe disposed at the pot lid 12. Further, in this embodiment, a barrier structure surrounding the opening of the arc-shaped avoidance groove 114 is formed at the upper surface of the lid body 11, and the sealing cover plate 10f is formed in an arc-shaped extended cover body. In this way, a side wall of the cover body formed by the sealing cover plate 10f is slidably fit with an outer wall of the barrier structure, and an arc length of the sealing cover plate 10f is greater than an arc length of the arc-shaped avoidance groove 114. In this way, as the pot lid rotates, the exhaust valve 17 drives the sealing cover plate 10f to slide along the barrier structure and constantly blocks the opening of the arc-shaped avoidance groove 114. An arrangement of the sealing cover plate 10f can effectively prevent liquid from being discharged from the exhaust valve 17 or the ingredients from flowing into the lid body 11.

It should be noted that, as illustrated in FIG. 12, the lid body 11 may include front lid and an inner lid. The front lid covers an outer surface of the inner lid. The front lid may partially cover or completely cover the outer surface of the inner lid. The above-mentioned arc-shaped avoidance groove 114 extends through both the front lid and the inner lid, and the barrier structure may be disposed at the outer surface of the front lid. In this way, the entire arc-shaped avoidance groove 114 can be shielded and not exposed, enhancing the structural aesthetics. In other embodiments, the sealing cover plate 10f may be located between the front lid and the inner lid.

In the accompanying drawings of this embodiment, same or similar components are denoted by same or similar reference numerals. In the description of the present disclosure, it should be understood that the orientation or the position indicated by terms such as “top,” “bottom,” “left,” and “right” should be construed to refer to the orientation or the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure. Therefore, the terms used to describe the positional relationship in the accompanying drawings are only used for illustrative purposes and cannot be understood as limitations on this patent. For those of ordinary skill in the art, the specific meanings of the above-mentioned terms can be understood according to specific circumstances.

The above are only some embodiments of the present disclosure, and are not intended to limit the present disclosure. Any modification, equivalent replacement, improvement, etc. made within the spirit and principle of the present disclosure shall fall within the scope of the present disclosure.

What is claimed is:

1. An upper lid comprising:
a lid body;
a pot lid rotatably connected to the lid body and disposed within the lid body, the pot lid having a locking position at which the pot lid is locked to an outer pot of a pot body and an unlocking position at which the pot lid is unlocked from the outer pot;
a transmission member mounted at the lid body in a liftable and lowerable manner, the transmission member being switchable between a locked position and a released position; and
a driven member rotatably mounted at the lid body and in transmission connection with the pot lid;
wherein:
a central line of the transmission member is coaxial with a rotation axis of the driven member;
one of the transmission member and the driven member has a spiral groove, and the other one of the transmission member and the driven member is provided with a drive member inserted in the spiral groove; and
the transmission member is configured to, when being switched from the locked position to the released position, drive the driven member through an engagement between the drive member and the spiral groove to rotate and drive the pot lid to rotate to switch from the locking position to the unlocking position.

2. The upper lid according to claim 1, wherein the spiral groove has a first component by which the transmission member extends beyond the lid body, and a second component by which the pot lid rotates from the unlocking position to the locking position.

3. The upper lid according to claim 1, wherein:
the spiral groove is one of a plurality of spiral grooves arranged at intervals in a rotation direction of the pot lid; and
the drive member is one of a plurality of drive members arranged in one-to-one correspondence with the plurality of spiral grooves.

4. The upper lid according to claim 1, wherein:
the driven member has a mounting recess, the spiral groove being formed on a wall of the mounting recess; and
an end of the transmission member extends into the mounting recess in which the drive member is disposed.

5. The upper lid according to claim 1, wherein:
the lid body has a movement channel extending through the lid body in a lifting-lowering direction of the transmission member; and
an end of the transmission member is in transmission connection with the driven member, and the other end of the transmission member passes through the movement channel and extends out of the lid body.

6. The upper lid according to claim 1, wherein:
the central line of the transmission member is coaxial with a rotation axis of the pot lid; and
the driven member is fixedly connected to the pot lid.

7. The upper lid according to claim 1, further comprising:
an exhaust valve;
wherein:
the driven member has a receiving groove formed in the driven member, and the pot lid has a pressure relief port formed at a center of the pot lid, the pressure relief port being in communication with the receiving groove; and
the exhaust valve is movably mounted in the receiving groove to open or close the pressure relief port.

8. The upper lid according to claim 7, further comprising:
a handle assembly connected to the transmission member, an exhaust channel being formed in the handle assembly and in communication with the exhaust valve, and an exhaust port of the exhaust channel being formed at a side surface of the handle assembly.

9. The upper lid according to claim 8, wherein:
the handle assembly includes:
a handle base housing mounted at an upper surface of the lid body; and
a bubble-breaking cover covering the handle base housing; and
the handle base housing and the bubble-breaking cover are engaged with each other to form an exhaust channel.

10. The upper lid according to claim 8, further comprising:
a pressure relief button movably mounted at the handle assembly and in transmission connection with the exhaust valve, the pressure relief button being configured to drive the exhaust valve to lift in the receiving groove to bring the pressure relief port into communication with the exhaust channel.

11. The upper lid according to claim 1, further comprising:
a suspension shaft connecting the driven member with the pot lid, the pot lid being rotatably disposed below the lid body by the suspension shaft;
wherein:
the driven member is connected to a shift fork extending from the driven member towards an edge of the pot lid, the shift fork having a driving groove; and
the pot lid is connected to a shift rod located at a distance from a rotation axis of the pot lid, the shift rod being configured to be movably inserted into the driving groove.

12. The upper lid according to claim, further comprising:
an exhaust valve; and
a sealing cover plate;
wherein:
the pot lid has a pressure relief port, a gap being formed between the pressure relief port and a rotation axis of the pot lid in a radial direction of the pot lid;
the lid body has an arc-shaped avoidance groove;
the sealing cover plate is movably mounted at the lid body and configured to constantly cover an opening of the arc-shaped avoidance groove; and
the exhaust valve is movably mounted at the sealing cover plate and configured to open or close the pressure relief port.

13. The upper lid according to claim 1, further comprising:
a rotation member provided with driven teeth, the rotation member being rotatably mounted at, and in transmission connection with, the pot lid;
wherein:
the central line of the transmission member is offset from a rotation axis of the pot lid;
the driven member is provided with transmission teeth at an outer circumferential wall of the driven member; and
the driven teeth are engaged with the transmission teeth.

14. The upper lid according to claim 13,
wherein:
the rotation member is a first rotation member, the transmission teeth are first transmission teeth, and the driven teeth are first driven teeth;
the pot lid has a pressure relief port on the rotation axis of the pot lid;
a rotation axis of the first rotation member is offset from the rotation axis of the pot lid; and
the first rotation member is provided with second transmission teeth;
the upper lid further comprising:
an exhaust valve movably mounted in the pressure relief port to open or close the pressure relief port; and
a second rotation member movably mounted at the lid body to slide about the rotation axis of the pot lid, the second rotation member being fixedly connected to the pot lid and provided with second driven teeth, and the second driven teeth being engaged with the second transmission teeth.

15. The upper lid according to claim 14, wherein:
the first driven teeth are separated from the second transmission teeth in a lifting-lowering direction of the transmission member; and
the first transmission teeth are separated from the second driven teeth in the lifting-lowering direction.

16. The upper lid according to claim 15, wherein:
the transmission member is a first transmission member; and
the second driven teeth are provided at an inner side surface of a second transmission member that is in a fan-ring shape.

17. The upper lid according to claim 16, wherein:
the first rotation member is provided with a connector protruding from an outer circumferential wall of the first rotation member, the first driven teeth being provided at a surface of the connector in a radial direction of the first rotation member;
the lid body is provided with a limit protrusion located between the connector and the exhaust valve, a surface of the connector in a circumferential direction of the first rotation member abutting against the limit protrusion when the transmission member is positioned at the locked position or the released position.

18. The upper lid according to claim 1, further comprising:
a sliding guide device;
wherein:
the lid body has a sliding guide channel extending in a circumferential direction of the pot lid, the sliding guide channel extending through the lid body in a lifting-lowering direction of the transmission member; and
an end of the sliding guide device is fixedly connected to the pot lid, and the other end of the sliding guide device at least partially protrudes into the sliding guide channel.

19. The upper lid according to claim 1, further comprising:
a plurality of balance units mounted at the lid body, the plurality of balance units being connected to the pot lid and arranged at intervals in a circumferential direction of the pot lid.

20. A cooking appliance comprising:
a pot body including an outer housing, an outer pot, and an inner pot; and
an upper lid provided at the pot body in an openable-closable manner, a cooking cavity being formed by sealing the outer pot with the upper lid, the upper lid including:
a lid body;
a pot lid rotatably connected to the lid body and disposed within the lid body, the pot lid having a locking position at which the pot lid is locked to the outer pot and an unlocking position at which the pot lid is unlocked from the outer pot;
a transmission member mounted at the lid body in a liftable and lowerable manner, the transmission member being switchable between a locked position and a released position; and
a driven member rotatably mounted at the lid body and in transmission connection with the pot lid;
wherein:
a central line of the transmission member is coaxial with a rotation axis of the driven member;
one of the transmission member and the driven member has a spiral groove, and the other one of the transmission member and the driven member is provided with a drive member inserted in the spiral groove; and
the transmission member is configured to, when being switched from the locked position to the released position, drive the driven member through an engagement between the drive member and the spiral groove to rotate and drive the pot lid to rotate to switch from the locking position to the unlocking position.
